(19) United States
(12) Patent Application Publication
(10) Pub. No.: US 2020/0320910 A1
(43) Pub. Date: Oct. 8, 2020

(54) DISPLAY DEVICE

(71) Applicant: SAKAI DISPLAY PRODUCTS CORPORATION, Sakai-shi, Osaka (JP)

(72) Inventor: RYUSUKE HORIBE, Sakai-shi, Osaka (JP)

(73) Assignees: SAKAI DISPLAY PRODUCTS CORPORATION, Sakai-shi, Osaka (JP); SAKAI DISPLAY PRODUCTS CORPORATION, Sakai-shi, Osaka (JP)

(21) Appl. No.: 16/304,140

(22) PCT Filed: May 23, 2016
(86) PCT No.: PCT/JP2016/065220

§ 371 Date: Nov. 22, 2018

(51) Int. Cl. G09F 9/40; G06F 3/14; G06F 3/147

(52) U.S. Cl. CPC G09F 9/40; G09F 9/35; G06F 3/147; G06F 3/1431

(57) ABSTRACT

A display device provided with a plurality of display panels, wherein the display device is characterized in that: the display device is provided with a single control unit for controlling the drive of the plurality of display panels, and a rigid substrate extending along one direction, in which a wiring for conveying an output signal from the control unit is formed; the rigid substrate and the plurality of display panels constitute panel groups connected in series via a flexible substrate along a direction perpendicular to the longitudinal direction of the rigid substrate; and the flexible substrate that connects the rigid substrate and the display panel disposed next to the rigid substrate is provided with a source driver.

### TECHNICAL FIELD

The present technique relates to a display apparatus for displaying an image.

### BACKGROUND ART

A multi-display apparatus has been proposed which sends out information in public spaces such as outdoors, storefronts, or transportation facilities (see Patent Literature 1, for example).

The multi-display apparatus for example includes a plurality of display panels and a plurality of controllers corresponding to the respective display panels. Each controller drives a corresponding one of the display panels.

### CITATION LIST

### Patent Literature

### [Patent Literature 1]

Japanese Patent Application Laid-Open Publication No. 2009-162999

### SUMMARY OF INVENTION

### Technical Problem

However, a multi-display apparatus according to certain specifications includes a large number of display panels, requiring a large number of controllers corresponding to the large number of display panels.

The present invention has been made in view of the circumstances described above, and an object thereof is to provide a display apparatus that requires fewer controllers for driving a plurality of display panels.

### Solution to Problem

A display apparatus according to an embodiment of the present invention includes a plurality of display panels, a single controller, and a rigid board. The controller controls driving of the display panels. The rigid board is elongated in one direction and provided with lines for conveying an output signal from the controller. The rigid board and the display panels are connected in series via flexible boards along a direction orthogonal to a longitudinal direction of the rigid board and thus form a panel group. The flexible boards include at least one flexible board connecting the rigid board with at least one of the plurality of display panels that is located next to the rigid board. The at least one flexible board has a source driver mounted thereon.

### Advantageous Effects of Invention

According to the above-described embodiment of the present invention, a single controller generates a control signal and a driving signal to be output to a plurality of display panels. It is therefore possible to reduce the number of controllers.

### BRIEF DESCRIPTION OF DRAWINGS

FIG. 1 is a diagram schematically illustrating a display apparatus according to Embodiment 1.

FIG. 2 is a schematic diagram illustrating arrangement of lines in the display apparatus.

FIG. 3 is a side view schematically illustrating the display apparatus viewed from short edges of the display panels.

FIG. 4 is a perspective view schematically illustrating the display apparatus attached to a prism.

FIG. 5 is a cross-sectional plan view schematically illustrating a display apparatus according to Embodiment 2 attached to a circular cylinder.

FIG. 6 is a side view schematically illustrating a display apparatus according to Embodiment 3 viewed from short edges of display panels.

FIG. 7 is a cross-sectional plan view schematically illustrating the display apparatus attached to the circular cylinder, the display apparatus including display panels formed from curved substrates.

FIG. 8 is a side view schematically illustrating a portion around one end and a portion around another end of a panel group viewed from short edges of display panels according to Embodiment 4.

FIG. 9 is a side view schematically illustrating a portion around one end and a portion around another end of a panel group viewed from short edges of display panels according to Embodiment 5.

FIG. 10 is a side view schematically illustrating a portion around one end and a portion around another end of a panel group viewed from short edges of display panels according to Embodiment 6.

### DESCRIPTION OF EMBODIMENTS

### Embodiment 1

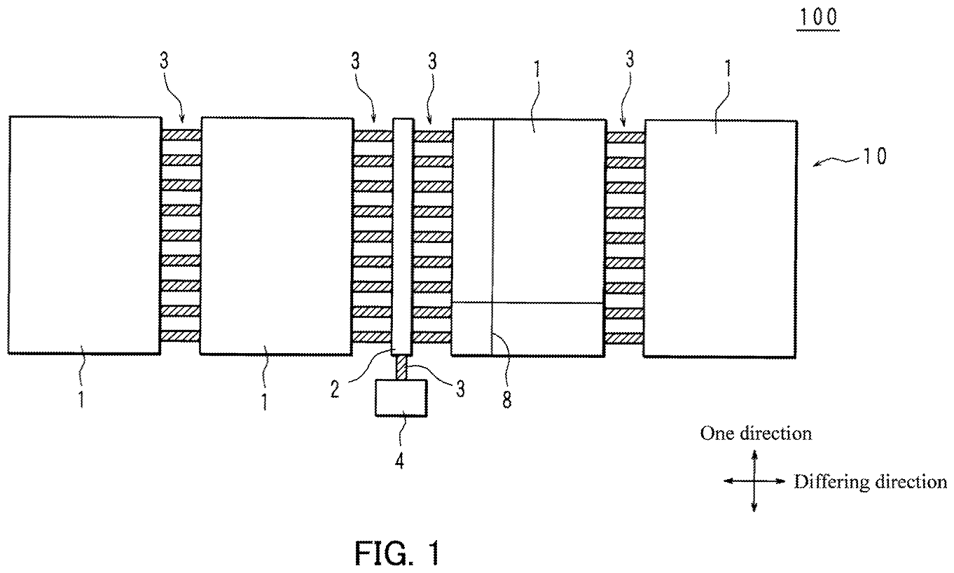

The following describes a display apparatus 100 according to Embodiment 1 based on the drawings. FIG. 1 is a diagram schematically illustrating the display apparatus 100. The display apparatus 100 includes a plurality of (four, according to the present embodiment) display panels 1 including a liquid crystal, a rigid board 2, and a single control board 4 (a controller) that controls driving of the display panels 1. The rigid board 2 is for example formed of a glass epoxy board, a glass composite board, a paper phenol board, a paper epoxy board, or a composite board.

The rigid board 2 has a narrow rectangular shape elongated in one direction. Each display panel 1 has a rectangular shape elongated in the one direction. The display panels 1 are disposed at two sides of the rigid board 2 in a direction (also referred to below as a differing direction) orthogonal to a longitudinal direction (the one direction) of the rigid board 2 and are arranged in the differing direction.

Although FIG. 1 shows a single rigid board 2, the display apparatus 100 may include a plurality of rigid boards 2. In such a configuration, the rigid boards 2 are connected in series along the one direction via a flexible board 3 or the like.

Among the display panels 1, a long edge of a display panel 1 and a long edge of an adjacent display panel 1 are connected by one or more flexible boards 3. Among the display panels 1 and the rigid board 2, one long edge of the rigid board 2 and a long edge of an adjacent display panel 1 are connected by one or more flexible boards 3. Another long edge of the rigid board 2 and a long edge of an adjacent display panel 1 are connected by one or more flexible boards 3. Each flexible board 3 is a wiring board including: a substrate made of a thin film of polyimide, polyester (PET), or the like; a wiring pattern such as thin copper foil on the substrate; and a coat such as an insulative film for surface protection. Not only a wiring pattern but also an integrated circuit (IC) component such as a source driver or a gate driver can be mounted on the flexible board 3. The flexible board 3 on which an integrated circuit (IC) component is mounted is referred to particularly as a chip on film (COF).

Specifically, the display panels 1 and the rigid board 2 are connected in series along the differing direction via the flexible boards 3. The display panels 1, the rigid board 2, and the flexible boards 3 form a panel group 10. A connection direction in which the display panels 1 and the rigid board 2 are connected is equivalent to the differing direction.

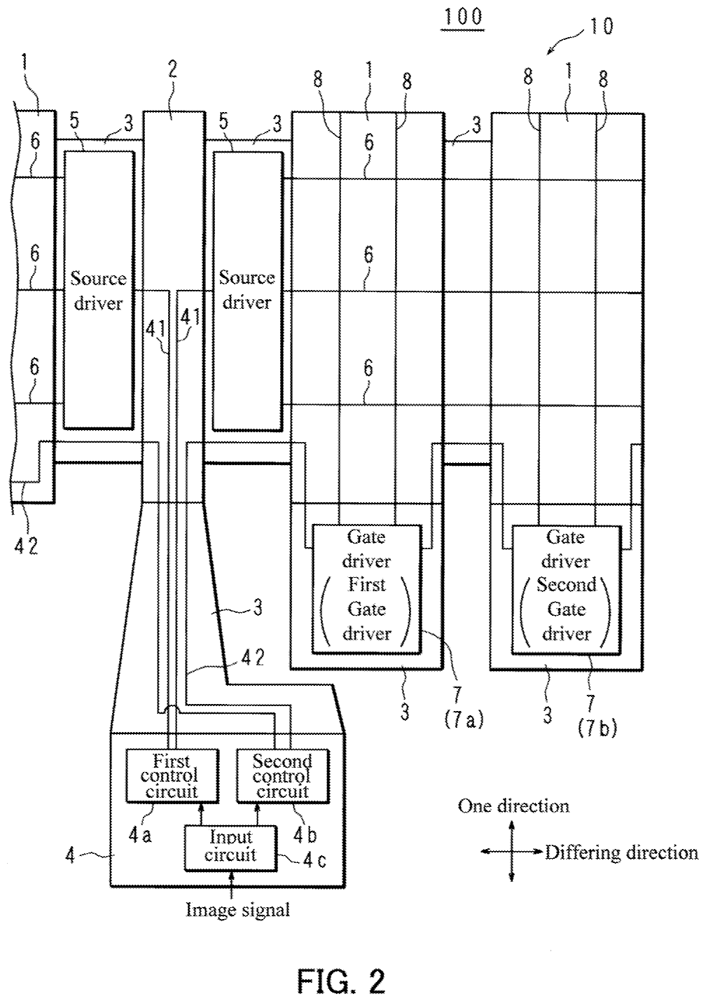

The control board 4 is connected with the rigid board 2 via a flexible board 3. Each display panel 1 is provided with a plurality of gate signal lines 8 extending in the one direction and arranged in the differing direction, and a plurality of source signal lines 6 extending in the differing direction and arranged in the one direction (see FIG. 2).

FIG. 2 is a schematic diagram illustrating arrangement of lines in the display apparatus 100. Source drivers 5 are respectively mounted on the flexible boards 3 that connect the rigid board 2 with the display panels 1. The source signal lines 6 for conveying source signals extend in the differing direction from each source driver 5. The source signal lines 6 from each source driver 5 span across the display panels 1 and the flexible boards 3 that connect these display panels 1.

Another flexible board 3 is attached to a short edge (an edge extending in the differing direction) of each display panel 1. A gate driver 7 is mounted on this flexible board 3. Specifically, the gate driver 7 is in a COF form, directly mounted on the panel, and there is no rigid board on and around the short edge. The gate signal lines 8 for conveying gate signals extend in the one direction from each gate driver 7. The gate signal lines 8 and the source signal lines 6 on the display panels 1 are substantially orthogonal to each other. Another form may alternatively be employed such as a gate on array (GOA) form in which a shift register and a group of gate lines for inputting control signals into the shift register are integrated with a panel (monolithic form). In such a configuration, no flexible board 3 is necessary for the short edge of each display panel 1.

An input circuit 4c for receiving image signals including image data representing images, and first and second control circuits 4a and 4b for respectively controlling the source drivers 5 and the gate drivers 7 based on clock signals and synchronization signals separated by the input circuit 4c are mounted on the control board 4.

The first control circuit 4a is connected with the source drivers 5 via first lines 41. The second control circuit 4b is connected with the gate drivers 7 via second lines 42. The first lines 41 are formed on the control board 4, the flexible board 3 that connects the control board 4 with the rigid board 2, the rigid board 2, and the flexible boards 3 that connect the rigid board 2 with the display panels 1. The first lines 41 are connected with each other.

The second lines 42 are formed on the control board 4, the flexible board 3 that connects the control board 4 with the rigid board 2, the rigid board 2, the flexible boards 3 that connect the rigid board 2 with the display panels 1, non-display regions of the display panels 1, the flexible boards 3 having the gate drivers 7 mounted thereon, and the flexible boards 3 that connect the display panels 1. The second lines 42 are connected with each other.

For example, as illustrated in FIG. 2, the second lines 42 that connect the second control circuit 4b with the gate driver 7 on the display panel 1 located next to the rigid board 2 (such a gate driver 7 is also referred to below as a first gate driver 7a) is formed on the control board 4, the flexible board 3 that connects the control board 4 with the rigid board 2, the rigid board 2, the flexible board 3 that connects the rigid board 2 with the display panel 1, the non-display region of the display panel 1, and the flexible board 3 having the first gate driver 7a mounted thereon. The second lines 42 are connected with each other.

Necessary signals are cascaded out from the gate driver 7 (the first gate driver 7a) on the display panel 1 located next to the rigid board 2 to the gate driver 7 on the display panel 1 that is the second from the rigid board 2 (such a gate driver 7 is also referred to below as a second gate driver 7b). The first and second gate drivers 7a and 7b are connected with each other through the non-display regions of the display panels 1 and the flexible boards 3 respectively having the first and second gate drivers 7a and 7b mounted thereon.

The flexible boards 3 respectively extending from the rigid board 2 in two directions orthogonal to the longitudinal direction of the rigid board 2 are used to dispose the display panels 1 to the left and right of the rigid board 2. Such a configuration allows the number of display panels 1 between the rigid board 2 and one end/another end of the panel group 10 to be reduced compared to a configuration in which the rigid board 2 is disposed at the one end/the other end of the panel group 10. As a result, formation of the first lines 41 and the second lines 42 on the flexible boards 3 that connect the display panels 1 can be simplified, reducing the load on the display panels 1 in light of the rigid board 2 or the drivers 5.

The first and second control circuits 4a and 4b generate signals necessary for displaying a single image in a single screen consisting of the panel group 10 including the plurality of display panels 1 as a whole. Specifically, the first control circuit 4a and the second control circuit 4b generate and output control signals such as a start signal, a clock signal, and an enable signal that are necessary for cyclic operation of the source drivers 5 and the gate drivers 7, respectively. The first control circuit 4a also outputs digital image data separated by the input circuit 4c to the source drivers 5.

The gate drivers 7 apply a scan signal to the gate signal lines 8 in sequence at predetermined time intervals within one frame period of the image data. The source drivers 5 receive digital image data of one horizontal scan period from the first control circuit 4a, generate an analog source signal representing one line of image, and apply the generated source signal to the source signal lines 6 in parallel. The source signal representing one line of image is updated at the predetermined time intervals.

The scan signal applied to one of the gate signal lines 8 is applied to gate electrodes of thin film transistors (TFTs, not shown) included in one line of pixels arranged in the one direction. The source signal applied to the source signal lines 6 is applied to pixel electrodes (not shown) via TFTs whose gates are connected to the one gate signal line 8 within the one horizontal scan period in which the scan signal is applied to the one gate signal line 8. Each pixel electrode has a capacitor, and the source signal is written into the capacitor. The source signal written into each pixel is kept for the one frame period.

According to the present embodiment, a single control board 4 handles generation of signals necessary for displaying a single image. Thus, the present embodiment eliminates the need for synchronization of a plurality of control boards 4 and provision of an additional control board necessary for the synchronization.

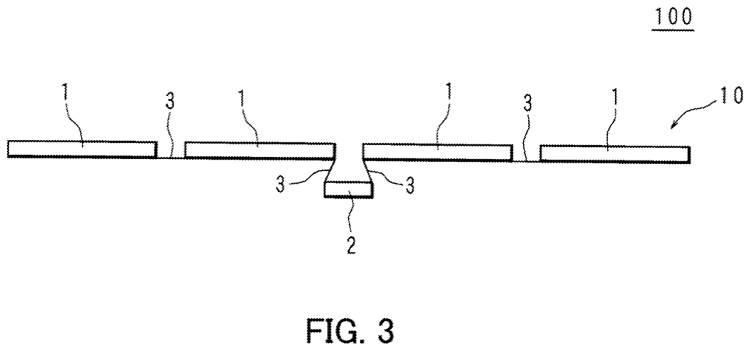

FIG. 3 is a side view schematically illustrating the display apparatus 100 viewed from the short edges of the display panels 1. Since the rigid board 2 and the display panels 1 located next to the rigid board 2 are connected by the flexible boards 3 as illustrated in FIG. 3, the rigid board 2 can be easily disposed in a position offset from positions of the display panels 1 toward a back side of the display panels 1. It is therefore possible to dispose the two display panels 1 next to the rigid board 2 with a small space therebetween and dispose the plurality of display panels 1 with a short distance therebetween. As a result, the display apparatus 100 can display a seamless image.

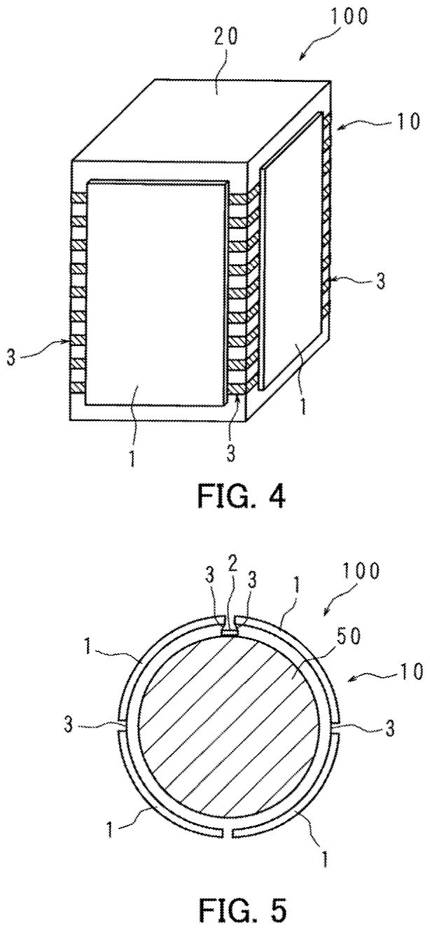

FIG. 4 is a perspective view schematically illustrating the display apparatus 100 attached to a prism 20. As illustrated in FIG. 4, the adjacent two display panels 1 are connected by the flexible boards 3, the rigid board 2 and the display panels 1 are connected by the flexible boards 3, and the flexible boards 3 bend along corners of the prism 20. Thus, the display panels 1 are attached to respective sides of the prism 20.

Note that although FIG. 4 shows the case of a quadrangular prism, the display apparatus 100 may be attached to a triangular prism or a prism 20 having five or more sides. In such an implementation, the number of the display panels 1 included in the display apparatus 100 is less than or equal to the number of sides of the prism 20. The implementation in which the display apparatus 100 is attached to the prism 20 is merely an example of an aspect of the use of the display apparatus 100. It is to be appreciated that the display apparatus 100 can be used simply as a large screen.

The display apparatus 100 according to Embodiment 1 requires fewer control boards 4, because a single control board 4 generates signals to be output to the plurality of display panels 1. A display apparatus having a plurality of control boards 4 corresponding to the respective display panels 1 needs to distribute and transmit a high-speed image data signal to the control boards 4. In a situation in which each display panel 1 is a 40 inch or more large-area panel, for example, a very long flexible flat cable (FFC) is needed for distribution wiring. Accordingly, the transmitted signal is more likely to be affected by disturbances, making it difficult to ensure the quality of the transmission. According to the present embodiment, the high-speed image data signal is transmitted to a single control board 4. Thus, the transmission is stable and of high quality. According to the present embodiment, the rigid board 2 is used as a source board, and thus a difference between an expansion coefficient of the display panels and an expansion coefficient of the source board can be restricted to a low level. As a result, the influence of heat generation, which causes expansion or contraction of components of the large display panels, can be reduced.

The flexible boards 3 respectively extending from the rigid board 2 in the two directions orthogonal to the longitudinal direction of the rigid board 2 are used to dispose the display panels 1 to the left and right of the rigid board 2. Such a configuration allows the number of display panels 1 between the rigid board 2 and the one end/the other end of the panel group 10 to be reduced compared to a configuration in which the rigid board 2 is disposed at the one end/the other end of the panel group 10. As a result, formation of the first lines 41 and the second lines 42 on the flexible boards 3 that connect the display panels 1 can be simplified, reducing the load on the display panels 1 as seen by the rigid board 2 or the drivers 5. Flexibility of the flexible boards 3 can be used to facilitate arrangement of the rigid board 2 toward back sides of the display panels 1 and a light source, allowing the distance between the display panels 1 respectively disposed at the two sides of the rigid board 2 to be short.

According to the present embodiment, a single control board 4 handles generation of signals necessary for displaying a single image. Thus, the present embodiment eliminates the need for synchronization of a plurality of control boards 4 and provision of an additional control board necessary for the synchronization. It is therefore possible to display the single image with the plurality of display panels 1 easily and conveniently.

### Embodiment 2

The following describes a display apparatus 100 according to Embodiment 2 based on the drawings. Elements of configuration of the display apparatus 100 according to Embodiment 2 that are similar to those according to Embodiment 1 are labelled using the same reference signs, and detailed description thereof is omitted.

FIG. 5 is a cross-sectional plan view schematically illustrating the display apparatus 100 attached to a circular cylinder 50. Unlike the display apparatus 100 according to Embodiment 1, the display apparatus 100 according to Embodiment 2 includes curved display panels 1. Specifically, as illustrated in FIG. 5, the display panels 1 curved along an outer circumferential surface of the circular cylinder 50 are prepared, and thus the display panels 1 can be attached to the outer circumferential surface of the circular cylinder 50 so as to span the entire circumference. Note that the rigid board 2 can be disposed between the circular cylinder 50 and the back side of the display panels 1.

In a configuration in which the rigid board 2 is curved to provide a curved display, there is a limitation on the curvature thereof, because mechanical bending stress is exerted on the board to cause defects such as wiring pattern disconnection, solder failure due to solder cracking, and component break. According to the configuration of the present invention, however, it is not necessary to curve the rigid board 2, and therefore mechanical stress is hardly exerted on the rigid board 2. Accordingly, defects such as mentioned above do not occur, eliminating the limitation on the curvature due to the rigid board 2. As a result, a rigid board having a smaller curvature can be used.

### Embodiment 3

The following describes a display apparatus 100 according to Embodiment 3 based on the drawings. Elements of configuration of the display apparatus 100 according to Embodiment 3 that are similar to those according to Embodiment 1 or 2 are labelled using the same reference signs, and detailed description thereof is omitted.

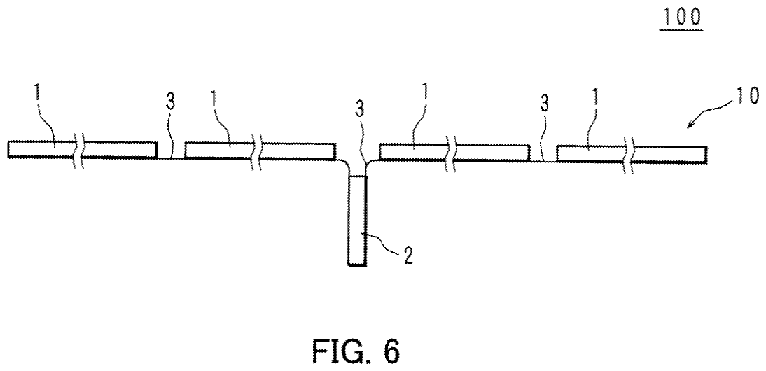

FIG. 6 is a side view schematically illustrating the display apparatus 100 viewed from the short edges of the display panels 1. The first and second lines 41 and 42 are formed on opposite surfaces of the rigid board 2. Accordingly, a specific long edge of one of the opposite surfaces of the rigid board 2 and a specific long edge of the other of the opposite surfaces of the rigid board 2 are respectively connected with the two display panels 1 located next to the rigid board 2 in the differing direction via the flexible boards 3. That is, the display panels 1 and the rigid board 2 are connected through linking by the flexible boards 3 along a thickness direction of the rigid board 2.

The distance between the display panels 1 disposed at the two sides of the rigid board 2 can be shorter in a configuration according to Embodiment 3 in which the flexible boards 3 connected to the display panels 1 are connected to the specific long edges of the rigid board 2 than in a configuration in which the flexible boards 3 are connected to both of the long edges of one surface of the rigid board 2. The configuration according to Embodiment 3 has another advantage. That is, the rigid board 2 does not block backlight when a backlight source (not shown) is disposed on the back side of the display panels 1.

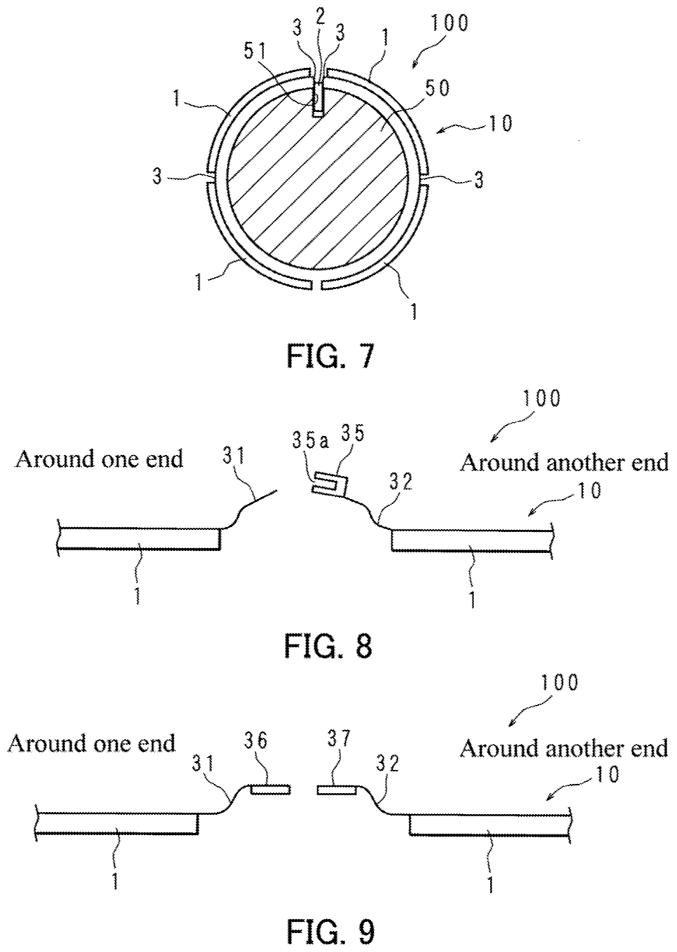

FIG. 7 is a cross-sectional plan view schematically illustrating the display apparatus 100 attached to the circular cylinder 50. The display apparatus 100 illustrated in FIG. 7 includes the display panels 1 formed from curved boards. Note that the circular cylinder 50 has a slit 51 for receiving insertion of the rigid board 2. The slit 51 is elongated in an axial direction of the circular cylinder 50.

When the display apparatus 100 including the display panels 1 formed from curved boards is attached to the outer circumferential surface of the circular cylinder 50, the rigid board 2 is inserted into the slit 51. The distance between the display panels 1 disposed at the two sides of the rigid board 2 can therefore be still shorter in the configuration according to Embodiment 3 than in a configuration in which the flexible boards 3 are connected to both of the long edges of one surface of the rigid board 2. Accordingly, the display apparatus 100 in which the distance between the display panels 1 is this short can display a more seamless image on a surface of a curved target such as the circular cylinder 50.

### Embodiment 4

The following describes a display apparatus 100 according to Embodiment 4 based on the drawings. Elements of configuration of the display apparatus 100 according to Embodiment 4 that are similar to those according to Embodiments 1 to 3 are labelled using the same reference signs, and detailed description thereof is omitted.

FIG. 8 is a side view schematically illustrating the one end and the other end of the panel group 10 viewed from the short edges of the display panels 1. These two ends of the panel group 10 are to be connected by a connection section. The connection section for example includes a first flexible board 31, a second flexible board 32, and a connector 35.

The first flexible board 31 is attached to the one end of the panel group 10. Specifically, the first flexible board 31 is attached to a distant long edge of the display panel 1 located at the one end of the panel group 10 from the adjacent display panel 1.

The second flexible board 32 is attached to the other end of the panel group 10. Specifically, the second flexible board 32 is attached to a distant long edge of the display panel 1 located at the other end of the panel group 10 from the adjacent display panel 1.

The first and second flexible boards 31 and 32 are connected with the source signal lines 6 and have lines formed thereon for conveying source signals generated by the source drivers 5.

The connector 35 to be connected with the first flexible board 31 is provided on a distal end of the second flexible board 32. The connector 35 for example includes a groove 35a for receiving insertion of the first flexible board 31. A user can connect the two ends of the panel group 10 together by inserting the first flexible board 31 into the groove 35a.

As a result of the two ends of the panel group 10 being connected through the connector 35, the lines formed on the first and second flexible boards 31 and 32 are connected, and source signals are input through the two ends of the panel group 10.

Note that the connector 35 to be connected with the second flexible board 32 may be provided on a distal end of the first flexible board 31, and the connector 35 and the second flexible board 32 may be connected.

Furthermore, another configuration may be employed in which the display panels 1 are disposed only at one of the two sides of the rigid board 2 to form the panel group 10, the rigid board 2 is disposed at one of the two ends of the panel group 10, one of the display panels 1 is disposed at the other of the two ends of the panel group 10, and the rigid board 2 and the one display panel 1 are connected by the connection section.

According to Embodiment 4, the two ends of the panel group 10 are connected by the connection section, and the same driving source signal is input into both ends of the lines on the display panels 1. Even if a disconnection occurs somewhere in the source signal lines 6, a supply voltage reaches a point of the disconnection as long as the source signal is input into both the ends of the lines. Therefore, the disconnection does not result in a line defect, and consequently the apparatus has improved fault tolerance.

The first flexible board 31 is attached to the one end of the panel group 10, the second flexible board 32 is attached to the other end, and the connector 35 is provided on one of the first flexible board 31 and the second flexible board 32. The two ends of the panel group 10 can be connected together by connecting the connector 35 with the other of the first flexible board 31 and the second flexible board 32. The use of the connector 35 facilitates connection of the two ends of the panel group 10 at an apparatus installation site.

### Embodiment 5

The following describes a display apparatus 100 according to Embodiment 5 based on the drawings. Elements of configuration of the display apparatus 100 according to Embodiment 5 that are similar to those according to Embodiments 1 to 4 are labelled using the same reference signs, and detailed description thereof is omitted.

FIG. 9 is a side view schematically illustrating the one end and the other end of the panel group 10 viewed from the short edges of the display panels 1. The two ends of the panel group 10 are to be connected by a connection section. The connection section for example includes the first flexible board 31, the second flexible board 32, a male connector 36, and a female connector 37.

The male connector 36 is provided on the distal end of the first flexible board 31. The female connector 37 is provided on the distal end of the second flexible board 32. The locations of the male connector 36 and the female connector 37 are interchangeable. A user can connect the two ends of the panel group 10 together by connecting the male connector 36 with the female connector 37. The male connector 36 and the female connector 37 are merely examples of connectors, and any other forms of connectors such as coupler connectors may be used.

As a result of the two ends of the panel group 10 being connected through the male connector 36 and the female connector 37, the lines formed on the first and second flexible boards 31 and 32 are connected, and source signals are input through the two ends of the panel group 10.

According to Embodiment 5, the first flexible board 31 is attached to the one end of the panel group 10, the second flexible board 32 is attached to the other end, and the male connector 36 and the female connector 37 are respectively attached to the first flexible board 31 and the second flexible board 32. The two ends of the panel group 10 can be connected together by connecting the two connectors 36 and 37. The use of the two connectors 36 and 37 facilitates connection of the two ends of the panel group 10 at an apparatus installation site.

Note that another configuration may be employed in which the display panels 1 are disposed only at one of the two sides of the rigid board 2 to form the panel group 10, the rigid board 2 is disposed at one of the two ends of the panel group 10, and one of the display panels 1 is disposed at the other of the two ends of the panel group 10. In such a configuration, the first flexible board 31 or the second flexible board 32 is attached to the rigid board 2.

### Embodiment 6

The following describes a display apparatus 100 according to Embodiment 6 based on the drawings. Elements of configuration of the display apparatus 100 according to Embodiment 6 that are similar to those according to Embodiments 1 to 5 are labelled using the same reference signs, and detailed description thereof is omitted.

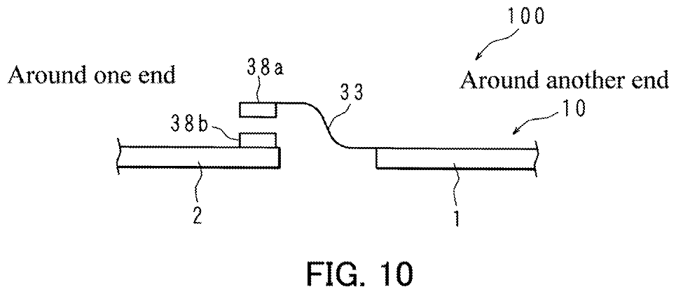

FIG. 10 is a side view schematically illustrating the one end and the other end of the panel group 10 viewed from the short edges of the display panels 1. The rigid board 2 is disposed at the one end of the panel group 10, and one of the display panels 1 is disposed at the other end of the panel group 10. The two ends of the panel group 10 are to be connected by a connection section. The rigid board 2 is provided with the source signal lines 6 connected to the source drivers 5.

The connection section for example includes connectors 38a and 38b, and a third flexible board 33 (an additional flexible board). The third flexible board 33 has the connector 38a mounted thereon, is connected with the source signal lines 6 on the display panels 1, and has lines formed thereon for conveying source signals generated by the source drivers 5. The connector 38b is mounted on the rigid board 2.

As a result of the two ends of the panel group 10 being connected through the connectors 38, the lines on the third flexible board 33 are connected with the source signal lines 6 on the second rigid board 2, and source signals are input through the two ends of the panel group 10.

The third flexible board 33 is attached to the other end of the panel group 10. Specifically, the third flexible board 33 is attached to a distant long edge of the display panel 1 located at the other end of the panel group 10 from the adjacent display panel 1. The connector 38a is mounted on the third flexible board 33. The connector 38b is mounted on the rigid board 2, and a user can connect the two ends of the panel group 10 together by connecting the connector 38a with the connector 38b on the rigid board 2. Note that another configuration may for example be employed in which the connector 38a is not mounted directly on the third flexible board 33 but is mounted on a rigid relay board, the third flexible board 33 is connected with the rigid relay board, and the connector 38a on the rigid relay board is connected with the connector 38b on the rigid board 2. Interposition of the rigid relay board increases the strength of the connection section.

According to Embodiment 6, the rigid board 2 is disposed at the one end of the panel group 10, the third flexible board 33 is attached to the other end of the panel group 10, and the connector 38a is attached to the third flexible board 33. The two ends of the panel group 10 can be connected together by connecting the connector 38a with the connector 38b on the rigid board 2. The use of the connectors 38 facilitates connection of the two ends of the panel group 10 at an apparatus installation site.

The connection method using the connectors 38a and 38b is merely an example for the connection section, and any other methods may be employed for the connection section. Although the connection sections according to Embodiments 4 to 6 include the connectors 35 to 38, connection sections that are connected by another connection method such as thermal compression bonding may be used instead of those including the connectors 35 to 38.

According to Embodiments 5 and 6, as in the case of Embodiment 4, the two ends of the panel group 10 are connected by the connection section, and the same digital signal output from the controller is input into both the ends of the lines on the display panels 1. Even if a disconnection occurs somewhere in the source signal lines 6, a supply voltage reaches a point of the disconnection as long as the source signal is input into both the ends of the lines. Thus, the apparatus has improved fault tolerance.

According to the above-described embodiments, a plurality of display panels 1 are disposed at one or both of the two sides of the rigid board 2 in the differing direction. However, one display panel 1 may be disposed at each of the two sides of the rigid board 2. The display apparatus 100 may include a plurality of panel groups 10 and a main control board that controls control boards 4 for controlling the respective panel groups 10. In such a configuration, the main control board performs synchronization control of the panel groups 10.

The following describes an example of a preferred embodiment of the present invention.

The rigid board of the display apparatus according to the present embodiment is preferably disposed between two of the display panels.

According to the present embodiment having such a configuration, flexible boards respectively extending from the rigid board (source board) in two directions orthogonal to the longitudinal direction (elongation direction, one direction) of the source board are used to dispose the display panels to the left and right of the longitudinally long source board. This configuration requires fewer panels to be disposed between the source board and one end of the panel group than a configuration in which the source board is disposed at the one end of the panel group. As a result, formation of lines on the flexible boards that connect the panels can be simplified. Furthermore, a distance between the source board and the one end of the panel group can be short, reducing the electrical load on the drivers and improving the quality of image display. Flexibility (bendability) of the flexible boards can be used to facilitate arrangement of the source board toward back sides of the display panels and the light source, allowing the distance between the display panels respectively disposed to the left and right of the source board to be short.

Preferably, the display panels and the rigid board of the display apparatus according to the present embodiment are connected through linking by the flexible boards along the thickness direction of the rigid board.

More specifically, according to the present embodiment having a configuration in which the display panels are disposed to the left and right of the source board, the flexible boards connected to the display panels are respectively connected to a specific long edge of the front surface of the source board and a specific long edge of the back surface of the source board. In such a configuration, the flexible boards can be shorter and the distance between the display panels disposed to the left and right of the source board can be shorter than in a configuration in which the flexible boards are respectively connected to opposed long edges of one surface of the source board.

The controller of the display apparatus according to the present embodiment may generate signals for displaying a single image in a single screen consisting of the panel group the plurality of display panels as a whole.

According to the present embodiment, a single controller handles generation of signals necessary for displaying a single image. Thus, the present embodiment eliminates the need for synchronization of a plurality of controllers and provision of a controller necessary for the synchronization. It is therefore possible to display the single image with the plurality of display panels easily and conveniently.

The display apparatus according to the present embodiment may include a connection section for connecting the two ends of the panel group in the connection direction.

According to the present embodiment having such a configuration, a source signal is input into both the ends of the lines. Even if a disconnection occurs somewhere in the source signal lines, therefore, a supply voltage reaches a point of the disconnection. Therefore, the disconnection does not result in a line defect, and consequently the apparatus has improved fault tolerance.

The connection section of the display apparatus according to the present embodiment may include a first flexible board attached to the one end of the panel group in the connection direction, a second flexible board attached to the other end of the panel group in the connection direction, and a connector that is attached to one of the first and second flexible boards and that is to be connected with the other of the first and second flexible boards.

More specifically, according to the present embodiment, the first flexible board is attached to the one end of the panel group, the second flexible board is attached to the other end, and the connector is provided on one of the first and second flexible boards. The two ends of the panel group can be connected together by connecting the connector with the other of the first and second flexible boards. The use of the connector facilitates connection of the two ends of the panel group at an apparatus installation site.

The connection section of the display apparatus according to the present embodiment may alternatively include a first flexible board attached to the one end of the panel group in the connection direction, a second flexible board attached to the other end of the panel group in the connection direction, and connectors that are respectively attached to the first and second flexible boards.

More specifically, according to the present embodiment, the first flexible board is attached to the one end of the panel group, the second flexible board is attached to the other end, and the two connectors are respectively provided on the first and second flexible boards. The two ends of the panel group can be connected together by connecting the two connectors. The use of the two connectors facilitates connection of the two ends of the panel group at an apparatus installation site.

The connection section of the display apparatus according to the present embodiment may alternatively include a third flexible board attached to the other end of the panel group in the connection direction and a connector that is attached to the third flexible board and that is to be connected with the rigid board, in a situation in which the rigid board is disposed at the one end of the panel group in the connection direction.

More specifically, according to the present embodiment, the rigid board is disposed at the one end of the panel group, the third flexible board is attached to the other end of the panel group, and the connector is attached to the third flexible board. The two ends of the panel group can be connected together by connecting the connector with the rigid board. The use of the connector facilitates connection of the two ends of the panel group at an apparatus installation site.

Note that the presently disclosed embodiments are merely examples in all aspects and should not be construed to be limiting. Any combinations of technical features described in the disclosed embodiments are possible. The scope of the disclosed embodiments is intended to include all variations within the scope of the claims and scope that is equivalent to the scope of the claims.

### REFERENCE SIGNS LIST

1 Display panel
2 Rigid board
3 Flexible board
4 Control board (controller)
41 First line (line)
42 Second line (line)
5 Source driver
10 Panel group
31 First flexible board
32 Second flexible board
33 Third flexible board
35, 38 Connector
36 Male connector (connector)
37 Female connector (connector)
100 Display apparatus

1. A display apparatus comprising:
a plurality of display panels;
a single controller configured to control driving of the display panels; and
a rigid board elongated in one direction and provided with lines for conveying an output signal from the controller,
the rigid board and the display panels being connected in series via flexible boards along a direction orthogonal to a longitudinal direction of the rigid board and thus forming a panel group,
the flexible boards including at least one flexible board connecting the rigid board with at least one of the plurality of display panels that is located next to the rigid board,
the at least one flexible board having a source driver mounted thereon.

2. The display apparatus according to claim 1, wherein
the rigid board is disposed between two display panels among the plurality of display panels.

3. The display apparatus according to claim 1, wherein
the plurality of display panels and the rigid board are connected in series via the flexible boards along a thickness direction of the rigid board.

4. The display apparatus according to claim 1, wherein
the controller generates signals for displaying a single image in a single screen consisting of the panel group as a whole.

5. The display apparatus according to claim 1, further comprising
a connection section configured to connect two ends of the panel group in a connection direction of the rigid board and the display panels.
